(19) United States
(12) Patent Application Publication
(10) Pub. No.: US 2005/0248754 A1
(43) Pub. Date: Nov. 10, 2005

(54) Wafer aligner with WEE (water edge exposure) function

(76) Inventors: Chun-Sheng Wang, Jhubei City (TW); Louie Liu, Hsin-Chu (TW); Li-Kong Turn, Taichung (TW); Heng-Hsin Liu, Yonghe City (TW); Chi-Hung Liao, Sanchong City (TW); Hsin-Chun Chiang, Shanhua Township (TW)

Correspondence Address: DUANE MORRIS LLP;IP DEPARTMENT (TSMC), 4200 ONE LIBERTY PLACE, PHILADELPHIA, PA, 19103-7396, US

(21) Appl. No.: 10/839,625

(22) Filed: May 5, 2004

(51) Int. Cl. G01B 11/00

(52) U.S. Cl. 356/150

(57) ABSTRACT

An improved photo resist coating and developing system comprising a track unit and a scanner unit is disclosed. The track unit has a coating unit for coating photo resist on a wafer. The scanner unit includes an enhanced wafer pre-alignment module, an expose stage, and a develop module. The enhanced wafer pre-alignment module is capable of performing wafer edge exposure (WEE) which conventionally required a separate WEE module as part of the track unit. By incorporating the WEE function into the wafer pre-alignment module of the scanner unit, the WEE module of the track unit is no longer required and duplication of wafer alignment and centering performed by the WEE module is eliminated.

The present invention relates to a wafer aligner for detecting the notch or orientation flat of a wafer, and more particularly to an improved wafer aligner in which a wafer edge exposure (WEE) function has been incorporated.

### BACKGROUND

A silicon wafer used in semiconductor fabrication is generally provided with a mark indicating the reference orientation position along the edge of the wafer, such as an orientation notch cut in a V or a U shape. During the semiconductor fabrication process, many of the process steps require the wafers to be aligned in certain orientation. This alignment typically requires the wafers to be placed with its geometric center centered on a rotational stage with the orientation notch oriented in a predetermined orientation. The alignment of the wafer at these process steps are carried out by a wafer aligner.

The detailed description of how such wafer aligners operate is not necessary here but it suffices to mention that a wafer aligner generally comprises an edge sensor that detects the orientation notch on a wafer and a centering mechanism that finds the geometric center of the wafer.

FIG. 2 illustrates a process flow for a conventional photo resist coating and development process presented in conjunction with the corresponding manufacturing tools that perform each of the process steps. At step 110, a photo resist coating module 115 applies a coat of photo resist on a wafer. At step 120, a wafer edge expose (WEE) module 125 exposes photo resist along the edge of the wafer. At step 130, a wafer aligner 135 aligns the wafer in preparation for the photo resist expose step. At step 140, an expose stage 145 exposes the photo resist with a pattern using a photo mask or a reticle. At step 150, a develop module 155 develops the photo resist. The three steps, coating 110, WEE 120 and develop 150 are conducted within a track unit 100A and the remaining steps, wafer align 130 and expose 140 are performed within a scanner unit 200A.

Before the WEE module 125 conducts the actual edge exposure process step, it aligns and centers the wafer to ensure that the WEE function is conducted properly. The wafer alignment and centering process conducted by the WEE module is same as the process conducted by a wafer aligner, described above. Thus, the WEE module comprises a wafer edge sensor for detecting the orientation notch, a centering mechanism for centering the wafer, and an exposure head for exposing the wafer's edge. The exposure head generally includes a UV light source and related exposure mechanism, including a robot to receive wafer, a ball srcew and a cylinder to manipulate the wafer and search for the orientation notch).

After the WEE module 125 completes the WEE operation, the wafer is transported from the track unit 100A to the scanner 200A for wafer expose step where a circuit pattern from a reticle is exposed on to the photo resist. Before the scanner 200A can properly perform the photo resist expose step, the wafer must be aligned by the pre-align module 135. The pre-align module 135 is a wafer aligner and aligns and centers the wafer just as the WEE module 125 had done in the track unit 10A. The pre-align module 135 comprises a wafer edge sensor for detecting the orientation notch and a centering mechanism for centering the wafer.

Thus, in a conventional photo resist coating and development process, the wafer aligning and centering operation is conducted twice, once by the WEE module 125 of the track unit 100 and a second time by the pre-align module 135 of the scanner unit 200A. This duplication adds unnecessary time to the overall manufacturing process time.

Thus, an improved photo resist coating and development process and equipment are needed.

### SUMMARY

According to an aspect of the present invention, an improved wafer pre-aligner for use in a photo resist exposing and developing system is disclosed. The improved wafer pre-aligner comprises an edge sensor for detecting an orientation notch on a wafer and an exposure mechanism. The exposure mechanism may comprise a light source for conducting wafer edge exposure; and a stepper motor for manipulating the wafer to a desired position after the orientation notch is found. The light source may be a UV light source. Thus, the improved wafer pre-aligner can perform the two operations: WEE and wafer aligning that are conducted by too separate tools in a conventional photo resist coating and developing system.

A photo resist coating and developing system according to an embodiment of the present invention is also disclosed. The photo resist coating and developing system comprises a track unit and a scanner unit. The track unit includes a photo resist coating module and the scanner unit includes a wafer pre-align module capable of performing the WEE function, an exposure stage, and a develop module.

According to another embodiment of the present invention, a method of coating and developing photo resist on a semiconductor wafer using a photo resist coating and developing system, wherein the system comprises a track unit and a scanner unit is disclosed. The method comprises steps of (a) coating a layer of photo resist on a semiconductor wafer in a track unit; (b) transferring the wafer to the scanner unit (c) aligning and centering the wafer; (d) performing wafer edge exposure; (e) exposing a pattern on the photo resist layer; and (f) developing the exposed photo resist layer, wherein the steps (c)-(e) are conducted in a scanner unit.

### BRIEF DESCRIPTION OF THE DRAWINGS

The invention will be better understood from the following detailed description of exemplary embodiments thereof in conjunction with the accompanying drawings in which:

FIG. 1 is a process flow illustrating the process steps involved in the photo resist coating and development process for a semiconductor wafer according to an embodiment of the present invention;

FIG. 2 is a process flow illustrating the process steps involved in a conventional photo resist coating and development process for a semiconductor wafer;

FIG. 3 is a schematic side view illustration of a wafer mounted on a conventional wafer pre-alignment module;

FIG. 4A is a schematic top plan view illustration of a wafer mounted on a wafer pre-alignment module that has been modified according to an embodiment of the present invention;

FIG. 4B is a schematic side view illustration of the wafer of FIG. 4A;

FIG. 5A is a schematic top plan view illustration of a wafer mounted on a pre-alignment module that has been modified according to another embodiment of the present invention; and

FIG. 5B is a schematic side view illustration of the wafer of FIG. 5A.

Features shown in the above referenced drawings are not intended to be drawn to scale, nor are they intended to be shown in precise positional relationship. Like reference numbers are used to illustrate like features in the various drawings.

### DETAILED DESCRIPTION

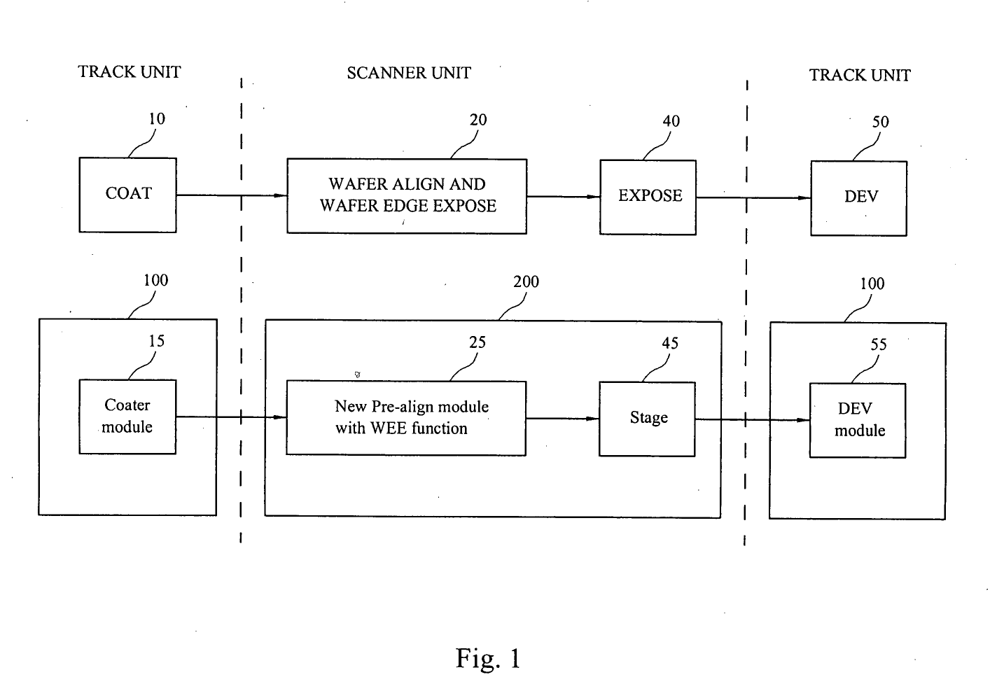

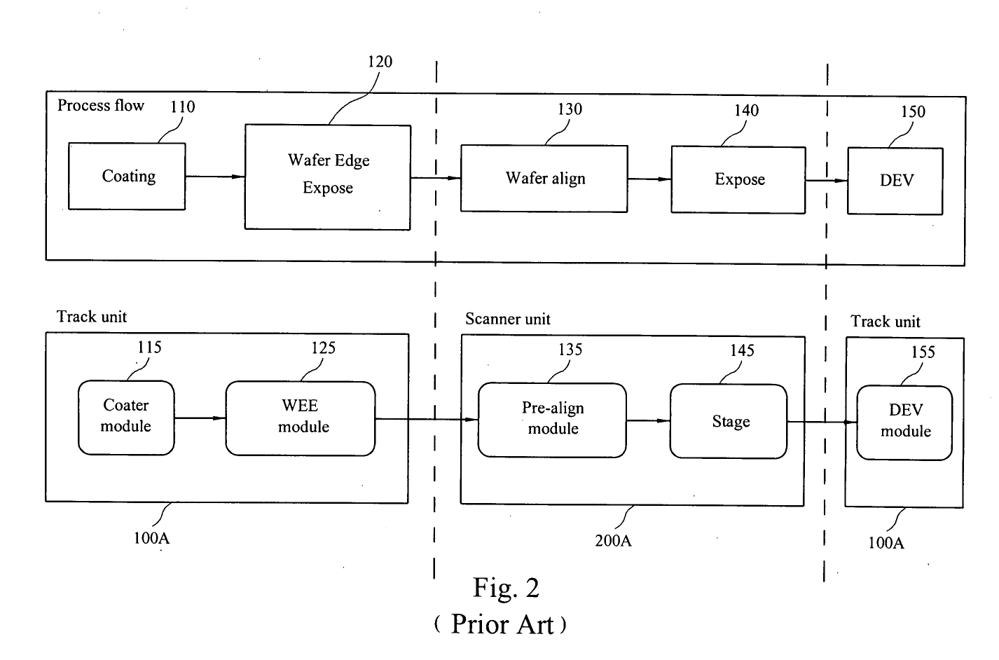

FIG. 1 illustrates a process flow for a photo resist coating and development process presented in conjunction with the corresponding manufacturing tools that perform each of the process steps. At step 10, a photo resist coating module 15 applies a coat of photo resist on a wafer. At step 20, an enhanced pre-alignment module 25 aligns the wafer in preparation for the photo resist expose and develop steps and performs the wafer edge expose (WEE) process step. At step 40, an expose stage 45 exposes the photo resist with a pattern using a photo mask or a reticle. At step 50, a develop module 55 develops the photo resist. The coating step 10 and the develop step 50 are conducted in the track unit 100, while the wafer align and Wee step 20 and expose step 40 are conducted in scanner unit 200. The enhanced pre-alignment module 25 incorporates the mechanisms necessary to perform both the WEE function and the wafer alignment function. This eliminates the need for the WEE module 125 found in the track unit 100A of the conventional photo resist coating and development system illustrated in FIG. 2. By incorporating the WEE function into the pre-alignment module 25 of the scanner unit 200, the wafer alignment and centering process need only be conducted once by the pre-alignment module 25. Thus, the overall process time for photo resist coating and development is shortened. The term “module” as used herein is synonymous with the term “tool” referring generally to a piece of machinery or equipment.

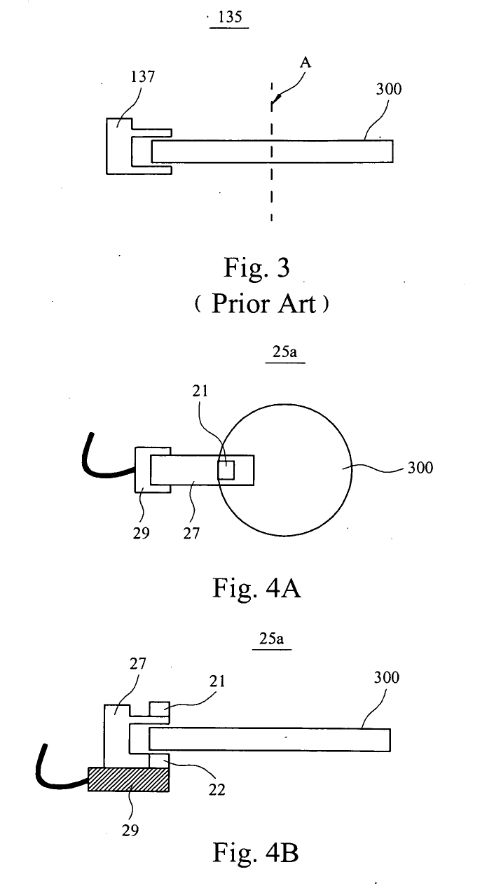

FIG. 3 is a schematic side-view illustration of a conventional wafer pre-alignment module 135 of the conventional photo resist coating and development process flow illustrated in FIG. 2. The working details of a conventional wafer aligner such as this aligner 135 is well known in the art and only the relevant aspects of such wafer aligner will be discussed here. The wafer pre-alignment module 135 is provided with an edge sensor 137 for monitoring the peripheral edge portion of a wafer 300 as the wafer is rotated about its axis A. The edge sensor 137 typically comprises at least one light source, such as an LED, (not shown) and at least one light detector (not shown) for detecting the orientation notch (not shown) of the wafer 300. The wafer pre-aligniment module 135 is typically also provided with a wafer centering mechanism. Such wafer centering mechanism is well known in the art and the details of such mechanism need not be discussed here. But, generally, when centering a wafer, the system can define wafer center by a receiver signal which is detected from an LED light. Then a X-Y ball screw and cylinder mechanism will “push” and rotate wafer to the center position.

FIGS. 4A and 4B are schematic illustrations of an enhanced pre-alignment module 25a according to one embodiment of the present invention, the enhanced pre-alignment module 25a includes the mechanism necessary for conducting the WEE function in addition to the standard wafer alignment and centering mechanism. FIG. 4A is a schematic top plan view and FIG. 4B is a schematic side view illustration of the enhanced pre-alignment module 25a. The enhanced pre-alignment module 25a comprises an edge sensor 27 for detecting the orientation notch (not shown) of the wafer 300. In the enhanced pre-alignment module 25a, the edge sensor 27 is modified to include an exposure mechanism (not shown) for the WEE function. The exposure mechanism comprises an additional light source 21, generally a UV light source; an additional light detector 22, generally one or more charge couple devices (CCD); and a stepper motor 29. The stepper motor can bring the wafer to center position in both X and Y direction.

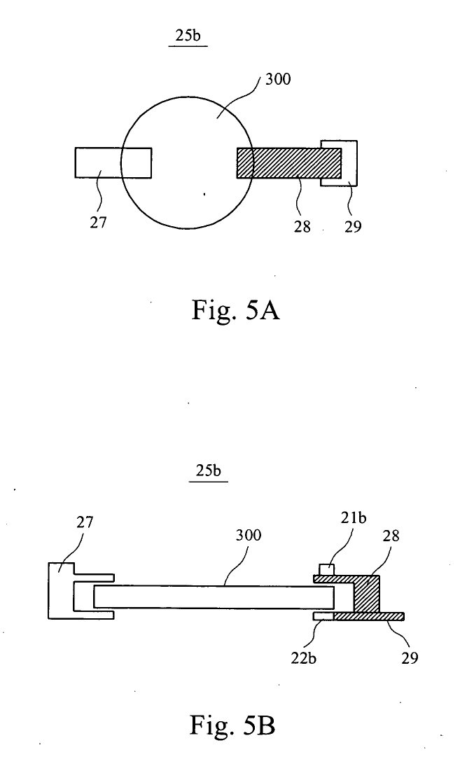

FIGS. 5A and 5B are schematic illustrations of another embodiment of the enhanced pre-alignment module 25b. FIG. 5A is a schematic top plan view and FIG. 5B is a schematic side view illustration of the enhanced pre-alignment module 25b. In this embodiment of the present invention, rather than adding the exposure mechanism for the WEE function to the edge sensor 27, an exposure head 28 and a stepper motor 29 is added to the enhanced pre-alignment module 25b separate from the edge sensor 27. The exposure head 28 comprises a light source 21b, generally a UV light source and a light detector 22b, generally one or more CCDs.

By incorporating the WEE function of a track unit into the wafer pre-alignment module of a scanner unit, duplication of wafer alignment and centering steps are eliminated. This reduces the overall process time required for the photo resist coating and development process in semiconductor wafer processing. The inventors have observed time savings of about 15 to 20 seconds in the overall photo resist coating and development process resulting from the present invention. Because the conventional WEE module is no longer required, additional capital equipment cost savings may be realized by implementation of the present invention.

While the foregoing invention has been described with reference to the above embodiments, various modifications and changes can be made without departing from the spirit of the invention. These various modifications are considered to be within the scope of the invention defined by the appended claims.

1.-5. (canceled)

6. A photo resist coating and developing system comprising:
a track unit having a photo resist coating module;
a scanner unit having a wafer pre-align module, wherein the wafer pre-align module is capable of performing a wafer edge exposure function;
an exposure stage; and
a develop module.

7. The photo resist coating and developing system of claim 6, wherein the wafer pre-align module comprising:
an edge sensor for detecting an orientation notch on a wafer; and
an exposure mechanism for conducting wafer edge exposure.

8. The photo resist coating and developing system of claim 7, wherein the exposure mechanism comprises:
a light source;
a light detector; and
a stepper motor.

9. The photo resist coating and developing system of claim 8, wherein the exposure mechanism is incorporated into the edge sensor.

10. The photo resist coating and developing system of claim 8, wherein the light source is a UV light source and the light detector is a charge couple device.

11. The photo resist coating and developing system of claim 8, wherein the exposure mechanism is provided on an exposure head.

12. A method of coating and developing photo resist on a semiconductor wafer using a photo resist coating and developing system comprising a track unit and a scanner unit, the method comprising steps of:
(a) coating a layer of photo resist on a semiconductor wafer in the track unit;
(b) transferring the wafer to the scanner unit;
(c) aligning and centering the wafer using a wafer pre-align module;
(d) performing wafer edge exposure using the wafer pre-align module;
(e) exposing a pattern on the photo resist layer using an expose stage; and
(f) developing the exposed photo resist layer using a develop module, wherein the steps (c) through (e) are conducted in the scanner unit.
